(19) United States
(12) Patent Application Publication
(10) Pub. No.: US 2018/0117969 A1
(43) Pub. Date: May 3, 2018

(54) PASSENGER ALL-STEEL TIRE AND TURN UP PROCESS IN BUILDING PROCESS THEREOF

(71) Applicant: QINGDAO DOUBLESTAR TIRE INDUSTRIAL CO., LTD., QINGDAO (CN)

(72) Inventors: SHUNQING QI, QINGDAO (CN); ZHENGTAO XING, QINGDAO (CN); YONG ZHANG, QINGDAO (CN); SHENGRI GAO, QINGDAO (CN); MEIQIN SONG, QINGDAO (CN)

(21) Appl. No.: 15/796,619

(22) Filed: Oct. 27, 2017

(30) Foreign Application Priority Data
Nov. 2, 2016 (CN) 201610951286.0
Nov. 2, 2016 (CN) 201621174597.2

(51) Int. Cl. B60C 9/00; B60C 5/14; B60C 9/16; B60C 13/02; B60C 15/04; B60C 15/00; B29D 30/32

(52) U.S. Cl. CPC B60C 9/0007; B60C 5/14; B60C 9/16; B60C 13/02; B60C 2009/0085; B60C 15/0036; B29D 30/32; B60C 2200/14; B60C 15/04

(57) ABSTRACT

The present application relates to the field of tires and provides a passenger all-steel tire and a turn-up process in a building process thereof. It is advantageous to improve tire strength, impact resistance, endurance and prolong service life. A longitudinal section of the passenger all-steel tire comprises a crown (1) located at an outer side of an upper portion, shoulders (2) located on two sides of the crown (1) and connected to the crown (1), a sidewall (3) connected to the shoulder (2), a bead (6) located at a lower portion of the sidewall (3) and matched with a rim, and a carcass (4) located at an inner side of the longitudinal section and the carcass (4) is a ply of all-steel carcass (41).

### CROSS-REFERENCE TO RELATED APPLICATION

This application claims priority to Chinese Patent Application No. 201610951286.0, filed on Nov. 2, 2016, and Chinese Patent Application No. 201621174597.2, filed on Nov. 2, 2016, which are hereby incorporated by reference in their entireties.

### TECHNICAL FIELD

The present application relates to the field of tires, and particularly to a passenger all-steel tire and a turn-up process in a building process thereof.

### BACKGROUND OF THE INVENTION

Passenger tires, including ordinary car tires, mud tires, light truck tires, etc., have characteristics of good braking performance and comfort, structures thereof are mostly radial structures and carcasses thereof are made of multi-layer polyester or nylon material, thereby ensuring tire safety and also providing better comfort. Ordinary car tires, also known as all terrain (AT) tires, can basically apply to several common road conditions. Mud tires, commonly known as MT tires or cross-country tires, are selected by cross-country enthusiasts and workers at special road sections. Compared with AT tires, MT tires have stronger side walls and more exaggerated tread patterns, and a distance between the patterns is significantly longer, so that it is easy to discharge mud at a low speed or throw off mud at a high speed when driving on a mud ground, and is much easier to increase tire traction on a ground with severe road conditions (such as rugged rocks). Light truck tires, commonly known as LT tires, have tire patterns between those of AT tires and MT tires, and carcasses thereof are mostly made of high-strength nylon material to ensure a higher load capacity.

### SUMMARY OF THE PRESENT INVENTION

An object of the present application is to provide a new type passenger all-steel tire and further provides a turn-up process in a building process of the passenger all-steel tire.

In one aspect, the present application provides a passenger all-steel tire, wherein a longitudinal section of the tire comprises a crown located at an outer side of an upper portion, shoulders located on two sides of the crown and connected to the crown, a sidewall connected to the shoulder, a bead located at a lower portion of the sidewall and matched with a rim, and a carcass located at an inner side of the longitudinal section and the carcass is a ply of all-steel carcass.

Preferably, the all-steel carcass is made of steel wire cords.

Preferably, a diameter of the steel wire cord is less than or equal to 0.75 mm and a single wire diameter is less than or equal to 0.20 mm.

Preferably, in percentage by weight, a carbon content of the steel wire in the steel wire cord is 0.65% to 0.75%.

Preferably, a breaking force of the steel wire in the steel wire cord is 500 N to 1100 N, and a stiffness of the steel wire in the steel wire cord is 45 T.S.U to 55 T.S.U.

Preferably, a base rubber is provided on an inner side of the crown, a cap ply is provided on an inner side of the base rubber, and a belt is arranged between the cap ply and the carcass.

Preferably, an inner liner is provided on an inner side of the carcass.

Preferably, the bead comprises a bead wire having a bead filling rubber coated on a circumference of the bead wire.

Preferably, a reinforcing ply is provided between the carcass and the sidewall and at a position of an end of the carcass, and an upper end of the reinforcing ply is higher than the end and a lower end of the reinforcing ply is lower than the end.

Preferably, the reinforcing ply is a steel wire reinforcing ply or nylon cloth.

Preferably, a section of the bead wire is hexagonal, quadrilateral or circular.

According to another aspect, the present application provides a turn-up process in a one-stage building process of the passenger all-steel tire, i.e., a first turn-up process, wherein comprises the following steps:

beads sleeving: forming a laminating assembly after semi-finished products are laminated, winding the laminating assembly around a carcass drum, sleeving two beads on an outer side of the laminating assembly and positioning the beads to predetermined positions to complete the beads sleeving; wherein the semi-finished products comprise a ply of all-steel carcass; after the beads sleeving, dividing the laminating assembly into three portions by the two beads, i.e., a first portion of the laminating assembly located between the two beads as well as a second portion and a third portion of the laminating assembly respectively located on two sides of the two beads;

pre-setting: inflating the first portion by the carcass drum, and allowing two ends of the first portion to be contracted to turn-up positions, so that the first portion is inflated and expanded, wherein an inflation pressure of the carcass drum is 0.3±0.1 Bar; and

turn-up: opening turn-up rods which are located on two sides of the carcass drum, coaxial with the carcass drum and extended to the two beads, so that the second portion and the third portion are supported by the turn-up rods; propelling the turn-up rods to the first portion along an axis from the two sides respectively to press the second portion and the third portion which have been turned up, thereby laminating the second portion and the third portion on the first portion to complete the turn-up, wherein an opening pressure of the turn-up rods is 4.5±0.5 Bar.

Still in another aspect, the present application provides a turn-up process in a two-stage building process of the passenger all-steel tire, i.e., a second turn-up process, wherein comprises the following steps:

finger-type sheets turn-down: forming a laminating assembly after semi-finished products are laminated together on a laminating drum, and extending the finger-type sheets out to cover two ends of the laminating assembly; the semi-finished products comprise a ply of the all-steel carcass;

beads sleeving: propelling bead propelling devices to the laminating assembly along the finger-type sheets from two sides of the laminating drum, and sleeving the two beads on an outer side of the laminating assembly and positioning the beads to predetermined positions by the bead propelling devices, pausing 2.5 to 3 s after the beads are sleeved, and then returning the finger-type sheets and the bead propelling devices to original positions; after the beads sleeving, dividing the laminating assembly into three portions by the two beads, i.e., a first portion of the laminating assembly located between the two beads as well as a second portion and a third portion of the laminating assembly respectively located on two sides of the two beads; and

turn-up: inflating and expanding turn-up bladders which are located at the two beads on the two sides of the laminating drum to support the second portion and the third portion by the inflated turn-up bladders, wherein an inflation pressure of the turn-up bladders is 0.4 to 0.5 Bar; propelling turn-up bladder squeezing devices to the turn-up bladders from the two sides respectively to squeeze the turn-up bladders, so that the second portion and the third portion are turned up and laminated on the first portion 1011 to complete the turn-up; pausing 5 to 6 s after the turn-up, and then pressing turn-up positions of the laminating assembly by a press roller under a high pressure of 0.2 to 0.25 Bar.

Preferably, a thickness of the finger-type sheet is 1.2 to 1.4 mm.

Preferably, a thickness of the turn-up bladder is 4.5 to 5 mm.

Improved designs of the passenger all-steel tire in the present application are concentrated in the carcass, the sidewalls and the beads. The improvements are advantageous to improve strength and safety and prolong a service life of the tire. Specific beneficial effects are as follows:

1. It adopts one ply of all-steel carcass made of steel wire cords instead of multiple plies of carcass made of nylon or polyester cords in the prior passenger tire, thereby reducing a weight of the passenger tire and improving the strength, endurance, high speed performance and impact resistance of the passenger tire.

2. According to the passenger all-steel tire of the present application, the all-steel carcass is made of steel wires with good flexibility, low stiffness and high strength, so that the passenger tire has high strength and good comfort performance, and also provides support for the implementation of the turn-up process in a production of the passenger all-steel tire.

3. According to the passenger all-steel tire of the present application, shoulder portions adopt a structure of crown coating sidewalls instead of a conventional structure of sidewalls coating crown, so that a manufacturability of a green tire is good.

4. According to the passenger all-steel tire of the present application, a cap ply is additionally arranged between the crown and the belt, and the cap ply has a good tightening function to the belt so that a shearing force generated during tire rolling can be reduced and the high speed performance can be improved.

5. According to the passenger all-steel tire of the present application, a reinforcing ply, which is located on an outer side of the end of the carcass and overlaps the end of the carcass, is additionally attached, so that shear heat at the end can be reduced, strength of the bead portions can be enhanced and a crack at the bead portions can be effectively avoided.

6. According to the passenger all-steel tire of the present application, the beads are hexagonal, quadrangular or in other structures to increase stability, safety and service life of the tire.

7. The turn-up process during a building process of the passenger all-steel tire provided by the present application can realize the turn-up of the all-steel carcass on a semi-steel tire building machine by improving process parameters and selecting the steel wire material, and has good turn-up effect, thus realizing productions of the passenger all-steel tires.

### BRIEF DESCRIPTION OF THE DRAWINGS

FIG. 1 is a front view of a passenger all-steel tire provided by one embodiment of the present application;

FIG. 2 is a perspective view of the passenger all-steel tire provided by one embodiment of the present application;

FIG. 3 is a schematic structural diagram of a prior passenger semi-steel tire;

FIG. 4 is a schematic structural diagram of the passenger all-steel tire provided by one embodiment of the present application;

FIG. 5 is an enlarged view of a shoulder portion in FIG. 4;

FIG. 6 is a structural comparison diagram between a bead of the prior passenger semi-steel tire in FIG. 3 and that of the passenger all-steel tire in FIG. 4;

FIG. 7 is a schematic diagram of steps of a first turn-up process in one embodiment of the present application; and

FIG. 8 is a schematic diagram of steps of a second turn-up process in one embodiment of the present application;

in which:

1: crown; 2: shoulder; 3: sidewall; 4: carcass; 41: all-steel carcass; 42: semi-steel carcass; 43: end of carcass; 5: inner liner; 6: bead; 61: bead wire; 62: bead filling rubber; 7: reinforcing ply; 8: base rubber; 9: cap ply; 10: belt; 101: laminating assembly; 1011: first portion; 1012: second portion; 1013: third portion; 102: turn-up rods; 103: finger-type sheets; 104: bead propelling device; 105: turn-up bladder; and 106: turn-up bladder squeezing device.

### DETAILED DESCRIPTION OF THE INVENTION

The present application will be described in detail by exemplary embodiments. However, it should be understood that, unless otherwise stated, the elements, structures and features in one embodiment may also be advantageously combined in other embodiments.

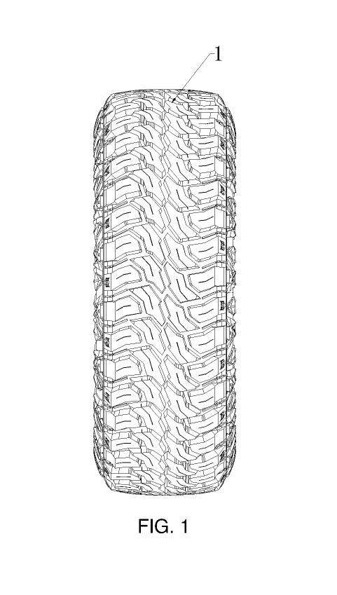

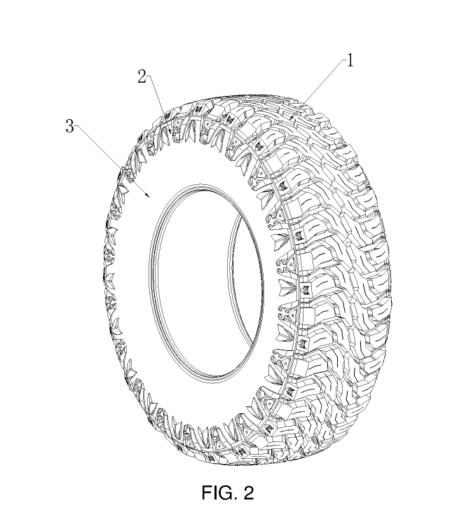

In the description of the present application, it should be noted that FIG. 1 is a front view of a passenger all-steel tire of the present application, with patterns comprising but not limited to FIG. 1; FIG. 2 is a perspective view of the passenger all-steel tire of the present application, with patterns comprising but not limited to FIG. 2, and a section of the front view is a longitudinal section. The positions or positional relationship indicated by the terms “inside”, “outside”, “upper”, “lower”, “front”, “rear”, and the like are positional relationship as shown in the drawings, which are merely used for facilitating the description of the present application, but not for indicating or implying that the devices or elements must have specific positions and be constructed and operated by the specific positions. Therefore, it should not be understood as any limitations to the present application.

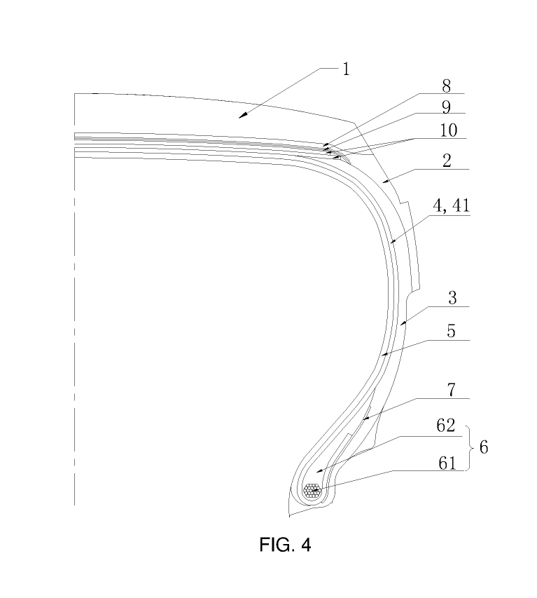

FIG. 4 is a schematic structural diagram of the passenger all-steel tire provided by one embodiment of the present application. As a longitudinal section of the passenger all-steel tire is symmetrical about a center line, only a half of the longitudinal section is shown in FIG. 4. As can be seen from FIG. 4, according to the passenger all-steel tire of the present application, the longitudinal section of the tire comprises a crown 1 located at an outer side of an upper portion, shoulders 2 located on two sides of the crown 1 and connected to the crown 1, a sidewall 3 connected to the shoulder 2, a bead 6 located at a lower portion of the sidewall 3 and matched with a rim, and a carcass 4 located at an inner side of the longitudinal section and the carcass is a ply of all-steel carcass 41.

The carcass 4 covers an inner contour of the passenger all-steel tire and are turned up to the beads 6 portions.

Preferably, the all-steel carcass 41 is made of steel wire cords.

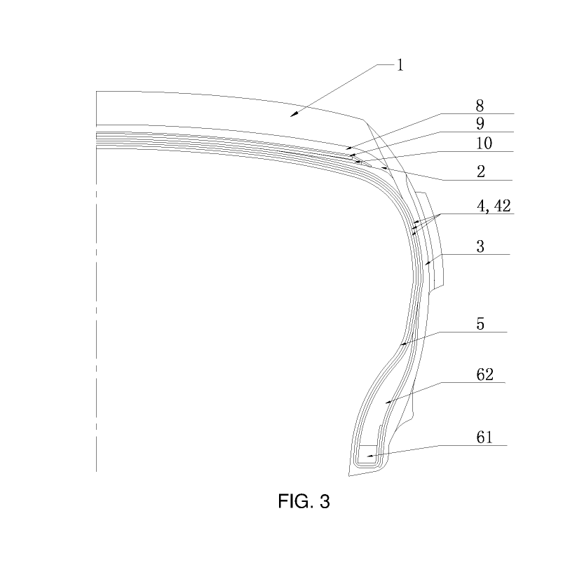

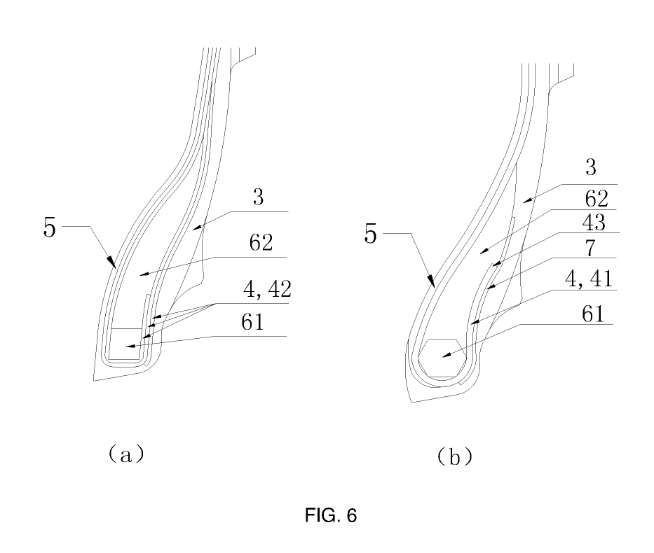

FIG. 3 is a schematic structural diagram of a prior passenger semi-steel tire, the carcass 4 of the prior passenger semi-steel tire comprises three plies of semi-steel carcass 42 made of nylon or polyester cords, wherein two inner plies of the semi-steel carcass 42 are turned up and an outer ply of the semi-steel carcass 42 is turned down (See FIG. 6(a)), such structure not only increases a weight of the tire, but also has complex production process. As shown in FIG. 4, compared with FIG. 3, the carcass 4 of the passenger all-steel tire of the present application adopts one ply of the all-steel carcass 41 made of steel wire cords instead of multiple plies of the semi-steel carcass 42 of the prior passenger semi-steel tire, thereby a weight of the tire is reduced, and strength and endurance of the tire are improved, and a production process is simplified. A method for preparing the all-steel carcass 42 from the steel wire cords adopts conventional production methods and is not described here.

Preferably, a diameter of the steel wire cord is less than or equal to 0.75 mm and a single wire diameter is less than or equal to 0.20 mm. In other words, the steel wire cord is a steel wire strand consisting of a plurality of single steel wires each having a single wire diameter of less than or equal to 0.2 mm, and a diameter of the steel wire strand is less than or equal to 0.75 mm.

Prior steel tires are mainly applied to heavy-duty trucks, but may not meet comfort requirements due to higher requirement on its carrying capacity, strength and stiffness, so that it is difficult to apply to passenger cars. The all-steel carcass 41 of the passenger all-steel tire in the present application can meet the requirements on the comfort of the passenger tire by adjusting the diameter of the steel wire cord so as the all-steel carcass 41 has good stiffness and flexibility.

Preferably, in percentage by weight, a carbon content of the steel wire in the steel wire cord is 0.65% to 0.75%. The flexibility and stiffness of the steel wire are adjusted to the optimum by adjusting the carbon content, so that the all-steel carcass 41 prepared from the steel wires is more suitable for the passenger all-steel tire in the present application, and the strength and comfort of the passenger all-steel tire can be further improved. It can be understood that the carbon content of the steel wire may also be 0.68%, 0.7%, 0.72%, etc., and those skilled in the art can adjust within the above range according to actual needs.

Preferably, a breaking force of the steel wire in the steel wire cord is 500 N-1100 N, and a stiffness the steel wire in the steel wire cord is 45 T.S.U-55 T.S.U. Wherein, T.S.U=97.974×10⁻³ N/mm performance of the steel wire is further limited within the above range so that the selected steel wires meet the requirements of the passenger all-steel tire of the present application better. It can be understood that the breaking force and the stiffness of the tire can be selected within the ranges according to performance needs and building process requirements of the passenger all-steel tire, e.g., the breaking force of the steel wire may also be 600 N, 800 N, 1000 N, etc., and the stiffness thereof may also be 48 T.S.U, 50 T.S.U, 52 T.S.U, etc.

Compared with ordinary steel wire cords for all-steel tires, the aforementioned steel wire cords consists of steel wires with good flexibility, low stiffness and high strength, and the prepared all-steel carcass 41 is capable of replacing the semi-steel carcasses 42 in the prior passenger semi-steel tire, which improves the strength, endurance, high speed performance and impact resistance without impairing riding comfort.

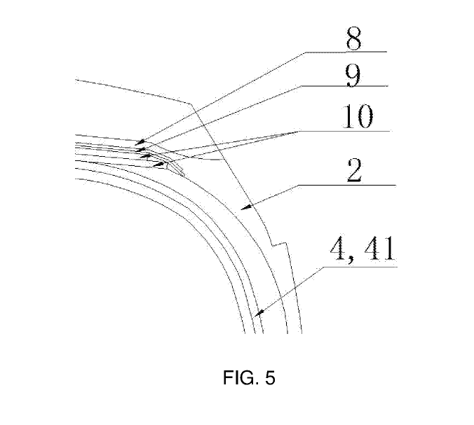

FIG. 5 is an enlarged view of a shoulder portion in FIG. 4. Referring to FIGS. 4 and 5, as one embodiment of the present application, a base rubber 8 is provided on an inner side of the crown 1, a cap ply 9 is provided on an inner side of the base rubber 8, and a belt 10 is arranged between the cap ply 9 and the carcass 4. The above structure can absorb shearing force generated when the tire rolling, to prevent early delamination.

The belt 10 is formed by taking high-strength high-modulus cords arranged at a small angle as a reinforcing material and coating with high hardness rubber, and is laminated on the outer side of the carcass in a circumferential direction of the tire, mainly playing a role of buffering and hooping the carcass 4. The cap ply 9 is laminated on an outer side of belt 10 for hooping the belt 10. In the embodiment, there are two plies of the cap ply 9 and two plies of the belt 10, but it can be understood that a number of plies of the cap ply 9 and a number of plies of the belt 10 can be one or more according to the requirements on performance of the passenger all-steel tire.

In comparison with FIG. 3 and FIG. 4, as one embodiment of the present application, the passenger all-steel tire of the present application adopts a structure of the crown 1 coating the sidewalls 3 instead of a conventional structure of the sidewalls 3 coating the crown 1, i.e., coating lower ends of the crown 1 to upper portions of the sidewalls 3; and thus a manufacturability of a green tire is good.

An inner liner 5 is provided on an inner side of the carcass 4 to prevent from air leakage.

Referring to FIG. 4, as one embodiment of the present application, the bead 6 comprises a bead wire 61 having a bead filling rubber 62 coated on a circumference of the bead wire 61.

The bead wire 61 is a bead ring formed by winding a plurality of steel wires.

Further referring to FIG. 4, preferably, a section of the bead filling rubber 62 is triangular.

Still referring to FIG. 4, as one embodiment of the present application, a section of the bead wire 61 is hexagonal. It can be understood that the section of the bead wire 61 may also be quadrilateral or circular to increase the stability, safety and service life of the tire.

FIG. 6(a) is a schematic structural diagram of a bead portion of the prior passenger semi-steel tire in FIG. 3, and FIG. 6(b) is a schematic structural diagram of a bead portion of the passenger all-steel tire of the present application in FIG. 4. Compared with FIG. 6(a), a reinforcing ply 7 is provided between the carcass 4 and the sidewall 3 and at a position of an end 43 of the carcass in FIG. 6(b), and the reinforcing ply 7 overlaps the end 43 of the carcass 4, i.e., an upper end of the reinforcing ply 7 is higher than the end 43 and a lower end of the reinforcing ply 7 is lower than the end 43. The reinforcing ply 7 is provided to reduce shear heat at the end 43 and avoid aging caused by heat, thereby prolonging the service life of the tire.

Further referring to FIG. 6(b), preferably, the lower end of the reinforcing ply 7 is overlapped the bead position, thus further enhancing strength of the beads and effectively preventing bead crack.

Preferably, the reinforcing ply 7 is a steel wire reinforcing ply or nylon cloth.

Components of the passenger all-steel tire excepting the carcass 4 are semi-finished products of the passenger semi-steel tires, so the passenger all-steel tire still needs to be built on a semi-steel tire building machine. However, because the carcass 4 of the passenger all-steel tire is the all-steel carcass 41, when carrying out turn-up and lamination on the conventional semi-steel tire building machine through a conventional turn-up process, because stiffness and strength of the steel wire cords in the all-steel carcass 41 are higher than those of nylon or polyester cords, interspace in beads, turn-up endpoint upwarping and other defects will occur and the turn-up step even cannot be completed, resulting in failing to carry out next process for production.

Therefore, the present application further provides a turn-up process in a building process of the passenger all-steel tire. In view of different types of the semi-steel tire building machine, the turn-up process is classified into a turn-up process in a one-stage building process of the passenger all-steel tire and a turn-up process in a two-stage building process of the passenger all-steel tire.

In one aspect, the present application provides a turn-up process in a one-stage building process of the passenger all-steel tire, i.e., a first turn-up process, as shown in FIG. 6, comprising the following steps:

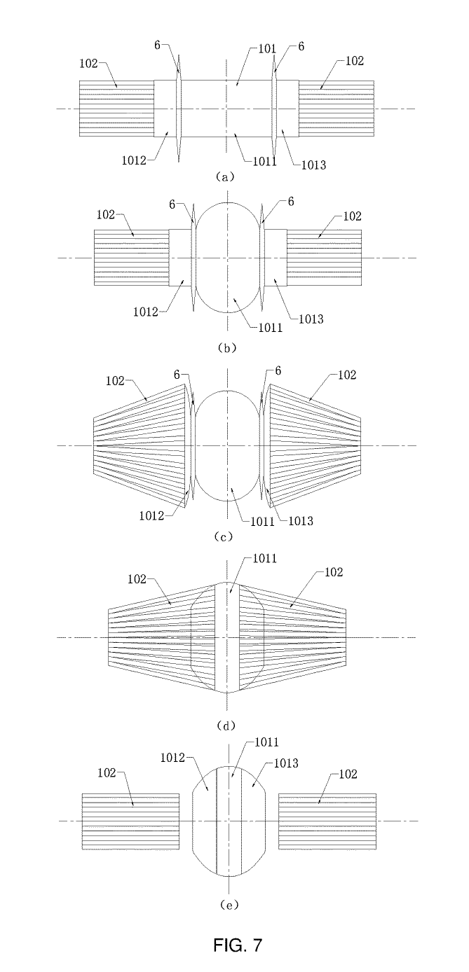

beads sleeving: as shown in FIG. 7(a), forming a laminating assembly 101 after semi-finished products are laminated, winding the laminating assembly 101 around a carcass drum, wherein the carcass drum is shaded by the laminating assembly 101, not shown in FIG. 7; sleeving the two beads 6 on an outer side of the laminating assembly 101 and positioning the beads 6 to predetermined positions to complete the beads sleeving; wherein the semi-finished products comprise a ply of all-steel carcass 41; after the beads sleeving, dividing the laminating assembly 101 into three portions by the two beads 6, i.e., a first portion 1011 of the laminating assembly 101 located between the two beads 6 as well as a second portion 1012 and a third portion 1013 of laminating assembly 101 respectively located on two sides of the two beads 6;

pre-setting: as shown in FIG. 7(b), inflating the first portion 1011 by the carcass drum, and allowing two ends of the first portion 1011 to be contracted to turn-up positions, so that the first portion 1011 is inflated and expanded, wherein an inflation pressure of the carcass drum is 0.3±0.1 Bar; and

turn-up: as shown in FIG. 7(c), opening turn-up rods 102 which are located on two sides of the carcass drum, coaxial with the carcass drum and extended to the two beads 6, so that the second portion 1012 and the third portion 1013 are supported by the turn-up rods 102; as shown in FIG. 7(d), propelling the turn-up rods 102 to the first portion 1011 along an axis from the two sides, respectively, to press the second portion 1012 and the third portion 1013 which have been turned up, thereby laminating the second portion 1012 and the third portion 1013 on the first portion 1011 to complete the turn-up, wherein an opening pressure of the turn-up rods 102 is 4.5±0.5 Bar.

In the above steps, the carcass drum is a cylindrical device arranged transversely and matched with the tire size, and the laminating assembly 101 is wound around a surface of the carcass drum to process it; the turn-up rods 102 consist of a plurality of rods arranged circumferentially around the axis. After the turn-up, the two beads 6 are respectively wrapped between the second portion 1012 which is turned up and the first portion 1011 and between the third portion 1013 which is turned up and the first portion 1011.

After the first turn-up process is completed, the turn-up rods 102 are returned back to original positions and a green tire is obtained, as shown in FIG. 7(e), and then subsequent processes are carried out.

According to requirements for turn-up of the all-steel carcass 41 made of the steel wire cords on the semi-steel tire one-stage building machine, the first turn-up process increases the inflation pressure of the carcass drum and the opening pressure of the turn-up rods, so that the all-steel carcass 41 can complete the pre-setting and the turn-up successfully, and the laminating effect is good, thereby building the passenger all-steel tire on the semi-steel tire one-stage building machine is realized.

According to another aspect, the present application provides a turn-up process in a two-stage building process of the passenger all-steel tire, i.e., a second turn-up process, comprising the following steps:

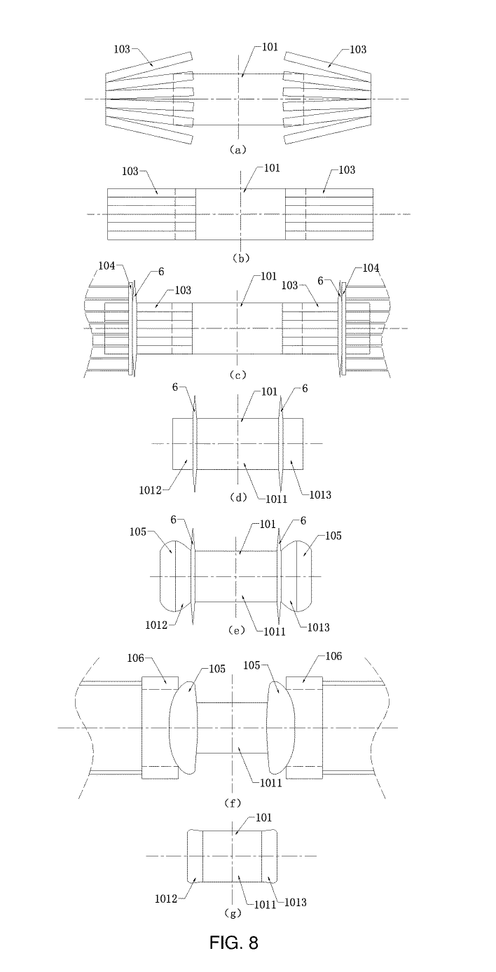

finger-type sheets turn-down: as shown in FIG. 8 (a)-(b), forming a laminating assembly 101 after semi-finished products are laminated together on a laminating drum, and extending finger-type sheets 103 out to cover two ends of the laminating assembly 101; the semi-finished products comprise a ply of the all-steel carcass 41; the laminating drum is shaded by the laminating assembly 101, not shown in FIG. 8;

beads sleeving: as shown in FIG. 8(c), propelling bead propelling devices 104 to the laminating assembly 101 along the finger-type sheets 103 from two sides of the laminating drum, and sleeving the two beads 6 on an outer side of the laminating assembly 101 and positioning the beads 6 to predetermined positions by the bead propelling devices 104, pausing 2.5 to 3 s after the beads 6 sleeved, and then returning the finger-type sheets 103 and the bead propelling devices 104 to original positions; as shown in FIG. 8(d), after the beads sleeving, dividing the laminating assembly 101 into three portions by the two beads 6, i.e., a first portion 1011 of the laminating assembly 101 located between the two beads 6 as well as a second portion 1012 and a third portion 1013 of the laminating assembly 101 respectively located on two sides of the two beads 6; and

turn-up: as shown in FIG. 8(e), inflating and expanding turn-up bladders 105 which are located at the two beads 6 on the two sides of the laminating drum to support the second portion 1012 and the third portion 1013 by the inflated turn-up bladders 105, wherein an inflation pressure of the turn-up bladders 105 is 0.4 to 0.5 Bar; as shown in FIG. 8(f), propelling turn-up bladder squeezing devices 106 to the turn-up bladders 105 from the two sides respectively to squeeze the turn-up bladders 105, so that the second portion 1012 and the third portion 1013 are turned up and laminated on the first portion 1011 to complete the turn-up; pausing 5 to 6 s after the turn-up, and then pressing turn-up positions of the laminating assembly 101 by a press roller under a high pressure of 0.2 to 0.25 Bar.

A first-stage green tire, as shown in FIG. 8(g), is obtained by the above steps.

In the above steps, the laminating drum is a cylindrical device arranged transversely and matched with the tire size, and the semi-finished products thereon are laminated and then the subsequent steps are carried out; and the finger-type sheets 103 consist of a plurality of sheets arranged circumferentially around an axis.

The bead propelling devices 104 are annular devices for feeding the beads 6 to predetermined positions.

The turn-up bladder squeezing device 106 is an annular device of which an inner diameter (as shown by broken line in FIG. 8 (f)) is larger than an outer diameter of the laminating drum and smaller than an outer diameter of the inflated turn-up bladders 105, so that the inflated turn-up bladders 105 can be squeezed and cover the first portion 1011 so as to turn up the second portion 1012 and the third portion 1013. After the turn-up, the two beads 6 are respectively wrapped between the second portion 1012 which is turned up and the first portion 1011 and between the third portion 1013 which is turned up and the first portion 1011.

According to requirements for turn-up of the all-steel carcass 41 made of the steel wire cords on the semi-steel tire two-stage building machine, the second turn-up process adjusts the inflation pressure of the turn-up bladders 105, the pausing time after the turn-up and the pressing pressure of the press roller, so that the all-steel carcass 41 can be turned up successfully, and the laminating effect is good, thereby building the passenger all-steel tire on the semi-steel tire two-stage building machine is realized.

Preferably, a thickness of the finger-type sheet 103 is 1.2 to 1.4 mm. The thickness of the finger-type sheet 103 is increased to 1.2 to 1.4 mm from conventional 0.8-1.0 mm, thus ameliorating the defects that the finger-type sheets 103 are easily deformed when grabbing the all-steel carcass 41 in the turn-down step and even the turn-down cannot be completed. The improved finger-type sheets 103 are of higher hardness, so that the all-steel carcass 41 can be grabbed successfully.

Preferably, a thickness of the turn-up bladder 105 is 4.5 to 5 mm. The thickness of the turn-up bladders 105 is increased to 4.5 to 5 mm from conventional 4.0 mm, so that applied force of the inflated turn-up bladders 105 for turning up the all-steel carcass 41 is much greater and service life of the bladders is prolonged.

Performance Tests:

The passenger all-steel tire manufactured by the turn-up process in the building process of the tire according to the present application and a passenger semi-steel tire with the same size are subject to performance tests on strength, stiffness, high speed and endurance, and the tests methods are as follows:

1. Strength Test:

Test tire size: 33*12.5R20

A test tire is mounted on a test rim to form a tire rim assembly and then inflated to 180 kPa; the tire rim assembly is fixed on a strength test machine, and five test points are determined equidistantly along an outer circumference of the tire, and the test is carried out point by point, an applied force F is applied incrementally until a crown of the test tire is pressed to be penetrated, and the applied force F and a penetrated depth p at a moment of stopping movement are measured and recorded at each test point; an energy of rupture W=(F×p)/2000.

2. Stiffness Test:

Test tire size: 33*12.5R20

A test tire is mounted on a test rim to form a tire rim assembly and then inflated to 250 kPa to carry out the following tests:

(1) Longitudinal stiffness test: (the longitudinal direction is a radial direction of the test tire)

a. The test tire is loaded to 80% of a rated load of the test tire at a radial loading speed of (50±2.5) mm/min, keeping pressure for 5 S, and the above steps are repeated for three times for trial test; and the gas pressure is adjusted to 250 kPa after the trial test;

b. The test tire is loaded to 80% of the rated load (test load) of the test tire at a radial loading speed of (50±2.5) mm/min, and keeping the pressure for 1 min after loading;

c. A test bed moves along the radial direction of the test tire, a generated relative displacement is taken as an x-coordinate, and a value of a generated longitudinal force applied on the test tire is taken as a y-coordinate to draw a curve of longitudinal stiffness; the movement speed of the test bed is (30-50) mm/min;

d. Calculation:

Longitudinal stiffness=(Longitudinal force 2−Longitudinal force 1)/(Longitudinal displacement 2−Longitudinal displacement 1)

Wherein:

The longitudinal force 1=(Reference longitudinal force−250N), the longitudinal displacement 1 is the displacement corresponding to the longitudinal force 1;

The longitudinal force 2=(Reference longitudinal force+250N), the longitudinal displacement 2 is the displacement corresponding to the longitudinal force 2;

The reference longitudinal force=Radial load applied in the test×30%×9.8 m/s², unit is N.

e. Unload and check the gas pressure to 250 kPa;

f. Steps b to e are repeated, wherein the test load in step b is replaced by the rated load of the test tire;

g. Steps b to e are repeated, wherein the test load in step b is replaced by 120% of the rated load of the test tire.

(2) Lateral Stiffness Test: (the Lateral Direction is an Axial Direction of the Tire)

a. The test tire is loaded to 80% of a rated load of the test tire at a radial loading speed of (50±2.5) mm/min, keeping pressure for 5 S, and the above steps are repeated for three times for trial test; and the gas pressure is adjusted to 250 kPa after the trial test;

b. The test tire is loaded to 80% of the rated load (test load) of the test tire at a radial loading speed of (50±2.5) mm/min, and keeping the pressure for 1 min after loading;

c. A test bed moves along the axial direction of the test tire, a generated relative displacement is taken as an x-coordinate, and a value of a generated lateral force applied on the test tire is taken as a y-coordinate to draw a curve of lateral stiffness; the movement speed of the test bed is (30-50) mm/min;

d. Calculation:

Lateral stiffness=(Lateral force 2−Lateral force 1)/(Lateral displacement 2−Lateral displacement 1)

Where:

The lateral force 1=(Reference lateral force−250N), and the lateral displacement 1 is the displacement corresponding to the lateral force 1;

The lateral force 2=(Reference lateral force+250N), and the lateral displacement 2 is the displacement corresponding to the lateral force 2;

The reference lateral force=Radial load applied in the test×30%×9.8 m/s², and unit is N.

e. Unload and check the gas pressure to 250 KPa;

f. Steps b to e are repeated, wherein the test load in step b is replaced by the rated load of the test tire;

g. Steps b to e are repeated, wherein the test load in step b is replaced by 120% of the rated load of the test tire.

3. High Speed Test

Test tire size: 215/75R15LT N (N is a speed symbol, representing a maximum driving speed of 140 km/h).

A test tire is mounted on a test rim to form a tire rim assembly and then inflated to a gas pressure corresponding to a maximum rated load marked on a sidewall of the test tire; the tire rim assembly is mounted on a high speed and endurance test machine, and the tire rim assembly is perpendicular to a surface of a test drum and then applied with a test load, and the test load is 90% of the maximum load of the single tire; the test is carried out according to conditions and steps in Table 1 until the tire is ruptured.

TABLE 1
High Speed Test Phase

| Test phase | Test speed/(km/h) | Test duration/min |
|---|---|---|
| 1 | 1 to Initial test speed | 10 |
| 2 | Initial test speed | 10 |
| 3 | Initial test speed +10 | 10 |
| 4 | Initial test speed +20 | 30 |

The initial test speed = Speed corresponding to speed symbol −20 km/h

4. Endurance Test

Test tire size: 215/75R15LT N, 6.50R16LT M (M is a speed symbol, representing a maximum driving speed of 130 km/h).

A test tire is mounted on a test rim to form a tire rim assembly and then inflated to a gas pressure corresponding to a maximum rated load marked on a sidewall of the test tire; the tire rim assembly is mounted on a high speed and endurance test machine, and the tire rim assembly is perpendicular to a surface of a test drum; a test speed for 215/75R15 N is 90 km/h, and a test speed for 6.50R16 M is 80 km/h; corresponding to different test phases in Table 2, corresponding test loads are applied until the tire is ruptured or unruptured but has passed the test.

TABLE 2
Endurance Test Phase

| | | Percentage of maximum rated |
|---|---|---|
| Test phase | Test duration/h | load of test tire/% |
| 1 | 4 | 75 |
| 2 | 6 | 95 |
| 3 | 24 | 115 |

Test Results Analysis:

The results of the above tests are shown in Table 3-7.

TABLE 3
Strength Test Results

| | | | Percentage of |
|---|---|---|---|
| | | Energy of | rupture energy to |
| Tire type | Tire size | rupture (J) | reference value % |
| Passenger semi-steel tire | 33*12.5R20 | 753 | 146.50 |
| Passenger all-steel tire | 33*12.5R20 | 931.9 | 181.30 |

TABLE 4
High Seed Test Results

| Tire type | Tire size | Result | Rupture form |
|---|---|---|---|
| Passenger semi- | 215/75R15LT N | 150 km/h 30 min | Shoulder |
| steel tire | | | chipping |
| Passenger all- | 215/75R15LT N | 180 km/h 10 min | Shoulder |
| steel tire | | | chipping |

TABLE 5
Endurance Test Results

| Tire type | Tire size | Result | Rupture form |
|---|---|---|---|
| Passenger semi- | 215/75R15LT N | 65 h | Bead crack |
| steel tire | | | |
| Passenger all- | 215/75R15LT N | 73 h 50 min | Bead crack |
| steel tire | | | |
| Passenger semi- | 6.50R16LT M | 54 h 30 min | Bead bulge |
| steel tire | | | |
| Passenger all- | 6.50R16LT M | 93 h 57 min | Unruptured |
| steel tire | | | |

TABLE 6
Stiffness Test Results

| | | | | Value of |
|---|---|---|---|---|
| | | | Load | stiffness |
| Tire type | Tire size | Category | rate % | N/mm |
| Passenger semi-steel | 33*12.5R20 | Lateral | 80 | 297.64 |
| tire | | stiffness | 100 | 291.20 |
| | | | 120 | 297.56 |
| Passenger all-steel | 33*12.5R20 | Lateral | 80 | 307.79 |
| tire | | stiffness | 100 | 326.76 |
| | | | 120 | 327.36 |
| Passenger semi-steel | 33*12.5R20 | Longitudinal | 80 | 492.02 |
| tire | | stiffness | 100 | 509.90 |
| | | | 120 | 496.64 |
| Passenger all-steel | 33*12.5R20 | Longitudinal | 80 | 505.95 |
| tire | | stiffness | 100 | 552.78 |
| | | | 120 | 378.82 |

TABLE 7
Weight Contrast

| Tire type | Tire size | Weight (kg) |
|---|---|---|
| Passenger semi-steel tire | 6.50R16 | 16.0 |
| Passenger all-steel tire | 6.50R16 | 15.8 |

As can be seen from Table 3 to Table 7, the passenger all-steel tire of the present application, compared with the passenger semi-steel tire with the same size, changes multiple plies of the carcass 4 into one ply, so that weight is reduced. Because the carcass 4 of the passenger all-steel tire is the all-steel carcass 41, strength of the tire is significantly improved. In the high-speed test results, the speed of the passenger all-steel tire can reach 180 km/h, while the speed of the passenger semi-steel tire is only 150 km/h, so that high speed performance of the passenger all-steel tire is better. In the endurance test results, running time of the passenger all-steel tire before rupture is significantly increased, especially the passenger all-steel tire with the size of 6.50R16LT M has not been ruptured yet after operating for 93 h and 57 min, and the endurance is improved significantly. In summary, compared with the passenger semi-steel tire with the same size, the strength, high speed performance and endurance of the passenger all-steel tire are improved, thus improving impact resistance and prolonging service life of the tire. Furthermore, because the cords of carcass adopts steel wire cords instead of polyester or nylon cords, the stiffness of the passenger all-steel tire is inevitably increased slightly, but difference value from that of the passenger semi-steel tire is within 40 N/mm, and thus the stiffness of the passenger all-steel tire can still meet the requirements of passenger tires.

It can be seen from the above test results that the performances of the passenger all-steel tire of the present application are greatly improved, which are more conducive for the passenger tire to adapt to various road conditions, especially various severe road conditions, and to prolong the service life. Meanwhile, it can also be concluded that the passenger all-steel tire obtained by the turn-up process in building of the tire provided by the present application has good laminating effect between the all-steel carcass 41 and adjacent components without interspace in beads, turn-up endpoint upwarping and other defects that affect the performance of the finished tires. Therefore, the turn-up process in the building process of the passenger all-steel tire according to the present application can completely meet production requirements of passenger all-steel tires building on the semi-steel tire building machine, so that production process is simple and the performance of the tire is good.

What is claimed is:

1. A passenger all-steel tire, wherein a longitudinal section of the tire comprises a crown (1) located at an outer side of an upper portion, shoulders (2) located on two sides of the crown (1) and connected to the crown (1), a sidewall (3) connected to the shoulder (2), a bead (6) located at a lower portion of the sidewall (3) and matched with a rim, and a carcass (4) located at an inner side of the longitudinal section and the carcass (4) is a ply of all-steel carcass (41).

2. The passenger all-steel tire according to claim 1, wherein, the all-steel carcass (41) is made of steel wire cords.

3. The passenger all-steel tire according to claim 2, wherein, a diameter of the steel wire cord is less than or equal to 0.75 mm and a single wire diameter is less than or equal to 0.20 mm.

4. The passenger all-steel tire according to claim 2, wherein, in percentage by weight, a carbon content of the steel wire in the steel wire cord is 0.65% to 0.75%.

5. The passenger all-steel tire according to claim 2, wherein, a breaking force of the steel wire in the steel wire cord is 500 N-1100 N, and a stiffness of the steel wire in the steel wire cord is 45 T.S.U-55 T.S.U.

6. The passenger all-steel tire according to claim 1, wherein, a base rubber (8) is provided on an inner side of the crown (1), a cap ply (9) is provided on an inner side of the base rubber (8), and a belt (10) is arranged between the cap ply (9) and the carcass (4).

7. The passenger all-steel tire according to claim 1, wherein, an inner liner (5) is provided on an inner side of the carcass (4).

8. The passenger all-steel tire according to claim 1, wherein, the bead (6) comprises a bead wire (61) having a bead filling rubber (62) coated on a circumference of the bead wire (61).

9. The passenger all-steel tire according to claim 1, wherein, a reinforcing ply (7) is provided between the carcass (4) and the sidewall (3) and at a position of an end (43) of the carcass, and an upper end of the reinforcing ply (7) is higher than the end (43) and a lower end of the reinforcing ply (7) is lower than the end (43).

10. The passenger all-steel tire according to claim 9, wherein, the reinforcing ply (7) is a steel wire reinforcing ply or nylon cloth.

11. The passenger all-steel tire according to claim 8, wherein, a section of the bead wire (61) is hexagonal, quadrilateral or circular.

12. A turn-up process in a one-stage building process of the passenger all-steel tire according to claim 1, that is, a first turn-up process, wherein, comprising the following steps:
beads sleeving: forming a laminating assembly (101) after semi-finished products are laminated, winding the laminating assembly (101) around a carcass drum, sleeving the two beads (6) on an outer side of the laminating assembly (101) and positioning the beads (6) to predetermined positions to complete the beads sleeving; wherein the semi-finished products comprise a ply of all-steel carcass (41); after the beads sleeving, dividing the laminating assembly (101) into three portions by the two beads (6), that is, a first portion (1011) of the laminating assembly (101) located between the two beads (6) as well as a second portion (1012) and a third portion (1013) of laminating assembly (101) respectively located on two sides of the two beads (6);
pre-setting: inflating the first portion (1011) by the carcass drum, and allowing two ends of the first portion (1011) to be contracted to turn-up positions, so that the first portion (1011) is inflated and expanded, wherein an inflation pressure of the carcass drum is 0.3±0.1 Bar; and
turn-up: opening turn-up rods (102) which are located on two sides of the carcass drum, coaxial with the carcass drum and extended to the two beads (6), so that the second portion (1012) and the third portion (1013) are supported by the turn-up rods (102); propelling the turn-up rods (102) to the first portion (1011) along an axis from the two sides, respectively, to press the second portion (1012) and the third portion (1013) which have been turned up, thereby laminating the second portion (1012) and the third portion (1013) on the first portion (1011) to complete the turn-up, wherein an opening pressure of the turn-up rods (102) is 4.5±0.5 Bar.

13. A turn-up process in a two-stage building process of the passenger all-steel tire, that is, a second turn-up process, wherein, comprising the following steps:
finger-type sheets turn-down: forming a laminating assembly (101) after semi-finished products are laminated together on a laminating drum, and extending finger-type sheets (103) out to cover two ends of the laminating assembly (101); the semi-finished products comprise a ply of the all-steel carcass (41);
beads sleeving: propelling bead propelling devices (104) to the laminating assembly (101) along the finger-type sheets (103) from two sides of the laminating drum, and sleeving the two beads (6) on an outer side of the laminating assembly (101) and positioning the beads (6) to predetermined positions by the bead propelling devices (104), pausing 2.5 to 3 s after the beads (6) are sleeved, and then returning the finger-type sheets (103) and the bead propelling devices (104) to original positions; after the beads sleeving, dividing the laminating assembly (101) into three portions by the two beads (6), that is, a first portion (1011) of the laminating assembly (101) located between the two beads (6) as well as a second portion (1012) and a third portion (1013) of the laminating assembly (101) respectively located on two sides of the two beads (6); and
turn-up: inflating and expanding turn-up bladders (105) which are located at the two beads (6) on the two sides of the laminating drum to support the second portion (1012) and the third portion (1013) by the inflated turn-up bladders (105), wherein an inflation pressure of the turn-up bladders (105) is 0.4 to 0.5 Bar; propelling turn-up bladder squeezing devices (106) to the turn-up bladders (105) from two sides respectively to squeeze the turn-up bladders (105), so that the second portion (1012) and the third portion (1013) are turned up and laminated on the first portion (1011) to complete the turn-up; pausing 5 to 6 s after the turn-up, and then pressing turn-up positions of the laminating assembly (101) by a press roller under a high pressure of 0.2 to 0.25 Bar.

14. The second turn-up process according to claim 13, wherein, a thickness of the finger-type sheet (103) is 1.2 to 1.4 mm.

15. The second turn-up process according to claim 13, wherein, a thickness of the turn-up bladder (105) is 4.5 to 5 mm.
